(19) United States
(12) Patent Application Publication
(10) Pub. No.: US 2026/0291602 A1
(43) Pub. Date: Sep. 24, 2026

(54) INTERFACES FOR AIRCRAFT SERVERS

(71) Applicant: Viasat, Inc., Carlsbad, CA (US)

(72) Inventor: Donald R. BUCHMAN, San Diego, CA (US)

(21) Appl. No.: 19/475,705

(22) PCT Filed: Apr. 18, 2023
(86) PCT No.: PCT/US2023/018939

§ 371 Date: Oct. 15, 2025

(51) Int. Cl. H04B 7/185; H04L 12/18

(52) U.S. Cl. CPC H04B 7/18506; H04L 12/189

(57) ABSTRACT

Methods, systems, and devices for interfaces for aircraft servers are described. A satellite communication system may schedule, in response to receiving a distribution request via an interface, content to be delivered to respective servers of one or more mobile platforms using background resources of a shared resource pool of the system. As part of scheduling and distributing other traffic, the system may identify unused resources of the shared resource pool, and may allocate those resources for transmitting the content. In some cases, the distribution request may include a time at which the content is scheduled to be available for access. However, the content may not have been delivered by the scheduled time. In such cases, if a user within a mobile platform requests the content, the system may allocate resources of the shared resource pool and may stream the content to the mobile platform.

### CROSS REFERENCE

The present Application is a 371 national phase filing of International Patent Application No. PCT/US2023/018939 by BUCHMAN entitled, “INTERFACES FOR AIRCRAFT SERVERS”, filed Apr. 18, 2023, which is assigned to the assignee hereof and is hereby incorporated by reference in its entirety.

### BACKGROUND

The following relates generally to communications, including interfaces for aircraft servers.

A satellite communication system may facilitate communication between an aircraft and a network to provide network access (e.g., to the Internet) to passengers or for other aircraft functions. The aircraft may also include a server to support the communication system, support connectivity, support user experience, and support aircraft operations (e.g., flight planning). However, the satellite communication system may have limited resources for communicating data, which may complicate managing traffic over the communication system.

### SUMMARY

The described techniques relate to improved methods, systems, devices, and apparatuses that support interfaces for aircraft servers. For example, the described techniques provide for a method that may include providing an interface for content distribution to respective servers on a set of mobile platforms using a shared resource pool of a communication network having communication links coupled with the set of mobile platforms. The method may include receiving, via the interface, a distribution request message, which may include a set of distribution parameters, to distribute content to at least a subset of the set of mobile platforms. The method may include determining resources of the shared resource pool for distributing the content based on the plurality of distribution parameters.

### BRIEF DESCRIPTION OF THE DRAWINGS

FIG. 1 shows an example of a satellite communication system that supports interfaces for aircraft servers in accordance with examples described herein.

FIG. 2 shows an example of an on-ground management system that supports interfaces for aircraft servers in accordance with examples described herein.

FIG. 3 illustrates an example of a process flow that supports interfaces for aircraft servers in accordance with aspects of the present disclosure.

FIG. 4 shows a block diagram of a beam manager that supports interfaces for aircraft servers in accordance with aspects of the present disclosure.

FIG. 5 shows a diagram of a system including a device that supports interfaces for aircraft servers in accordance with aspects of the present disclosure.

FIG. 6 shows a flowchart illustrating methods that support interfaces for aircraft servers in accordance with aspects of the present disclosure.

### DETAILED DESCRIPTION

Some satellite communication systems may support communications between mobile platforms (e.g., aircrafts) and a ground based network using various entities, such as communications satellites, satellite terminals, and terrestrial based communication stations. These entities may form communication links with mobile platforms to transmit and receive data upon request using a shared pool of communication resources (e.g., frequency resources, time resources). However, the communication system may experience periods in which traffic (e.g., data transmitted using the shared resource pool) may be lower than a capacity of the communication resources. Accordingly, the shared resource pool may have unused resources during these low-traffic periods. In addition, requests for distribution of content to mobile platforms may occur at times of congestion of the communication resources. Thus, management of communication resources for distributing content to mobile platforms may present challenges.

As described herein, a satellite communication system may schedule, in response to receiving a distribution request via an interface, content to be delivered to respective servers of one or more mobile platforms using background resources of a shared resource pool of the system. As part of scheduling and distributing other traffic (e.g., other data to be transmitted over the satellite communication system), the system may identify unused resources of the shared resource pool, and may allocate those resources for transmitting the content. The system may thus opportunistically transmit the content to the respective servers using the allocated resources. In some cases, the distribution request may include a time at which the content is scheduled to be available for access by a user within a mobile platform. However, because of the opportunistic nature of allocating background resources, the content may not have been delivered by the scheduled time. In such cases, if a user within a mobile platform requests the content, the system may allocate resources of the shared resource pool (e.g., resources used for normal traffic) and may stream the content (e.g., send the content in real-time) to the mobile platform.

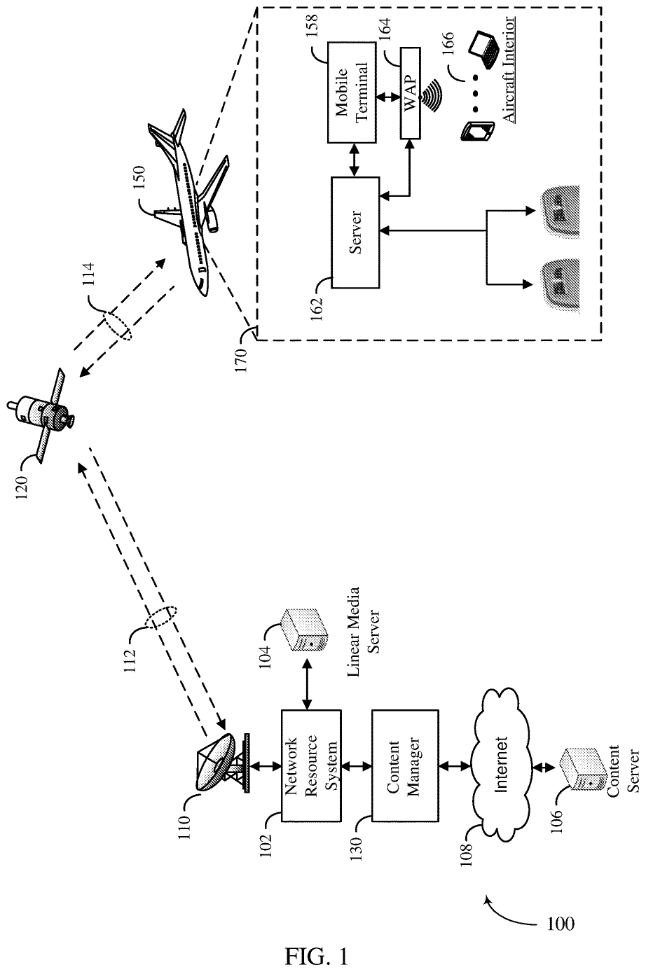

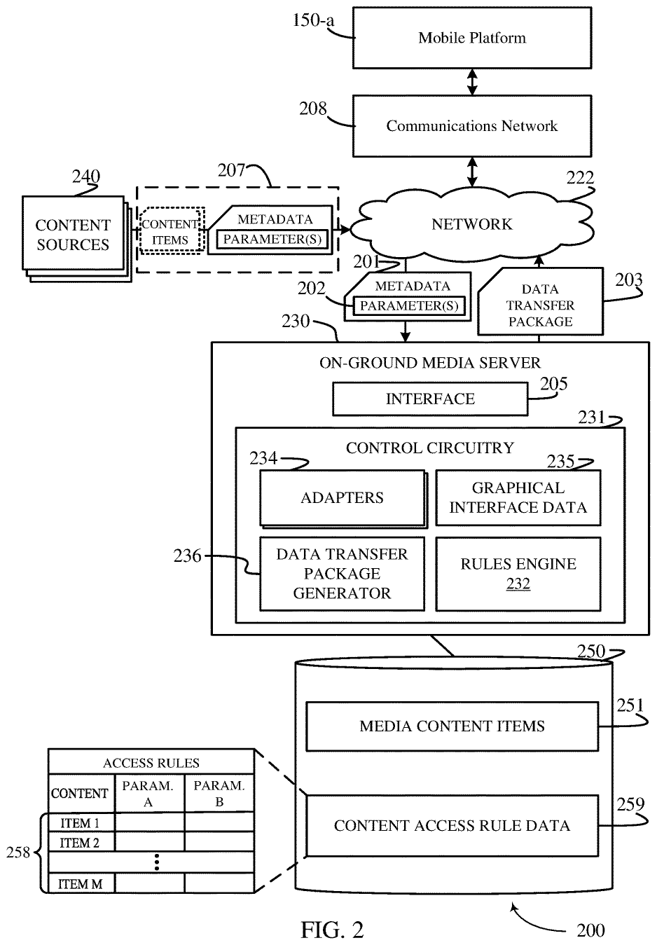

Aspects of the disclosure are initially described in the context of satellite communication systems with reference to FIG. 1. Aspects of the disclosure are further illustrated by and described with reference to systems, process flows, apparatus diagrams, system diagrams, block diagrams, and flowcharts that relate to interfaces for aircraft servers with reference to FIGS. 2 through 6.

FIG. 1 shows an example of a satellite communication system 100 that supports interfaces for aircraft servers in accordance with examples described herein. Satellite communication system 100 may include a satellite 120 in bidirectional communication with a ground terminal 110 via a feeder communication link 112. In some cases, ground terminal 110 may be known as an access node or a gateway. Satellite 120 may also be in bidirectional communication with a mobile platform 150 via a service communication link 114.

Accordingly, feeder communication link 112 and service communication link 114 may enable communication between mobile platform 150 and ground terminal 110 via satellite 120 while mobile platform 150 is stationary or in motion. Although a single ground terminal 110 is shown to avoid over complication of the drawing, the satellite communication system 100 may include many more ground terminals.

Ground terminal 110 may be in communication with a network resource system 102. Networks or communication links between ground terminal 110 and network resource system 102 may be any type of network and may include for example, the Internet, an IP network, an intranet, a wide area network (WAN), local area network (LAN), a virtual private network (VPN), a virtual LAN (VLAN), a fiber optic network, a cable network, a public switched telephone network (PSTN), a public switched data network (PSDN), a public land mobile network (PLMN), a cellular network, and/or any other type of network supporting communication as described herein.

In some examples, network resource system 102 may be in communication with a linear media server 104. Although FIG. 1 shows a single linear media server 104, the present application is not so limited and a plurality of linear media servers are also contemplated. Network resource system 102 and linear media server 104 may be in communication via any type of network.

Linear media server 104 may include one or more media servers, media storage devices, as well as other data stores. The linear media server 104 may for example be a cable television headend, satellite television headend, network bitstream of linear content, or any combination thereof. Linear media server 104 may be configured to provide linear media channels to network resource system 102. Linear media data generally refers to any stream of content that is scheduled for delivery at a certain time (e.g., a television show run at a set time, a live event, a televised sporting event, etc.). For example, various broadcast television channel offerings may be available from linear media server 104 and may be referred to as linear media channel data. Thus, when a user decides to select, for example, a “channel” carrying linear media content, the user effectively elects to consume whatever scheduled media is playing on that channel at that time; as opposed to directly selecting the media content item itself and initiating the media content item to begin playing at the beginning.

In some examples, network resource system 102 is also in communication with content server 106 via Internet 108 and/or other type of network. Although FIG. 1 shows a single content server 106, the present application is not so limited and a plurality of content servers are also contemplated. Content server 106 may include one or more servers, storage devices, etc., as well as other data stores. Content server 106 may be configured to provide network data to network resource system 102 in response to requests originating from passengers on mobile platform 150 (discussed in more detail below). Network data generally refers to requested on-demand content, for example Internet page content, YouTube or other audio and/or video content that is available for viewing from a user-selectable part of the content on-demand, text messaging, email messaging, other streaming data, and web browsing by the passengers on mobile platform 150.

As will be described in more detail below, network resource system 102 may be configured to schedule transmission of packets of the linear media channel data received from linear media server 104 and packets of the network content received from content server 106 to mobile platform 150 via ground terminal 110, feeder communication link 112, satellite 120 and service communication link 114 based at least in part on a congestion status of one or both of feeder communication link 112 and service communication link 114. The functions of the network resource system 102 may be implemented in hardware, instructions embodied in a memory and formatted to be executed by one or more general or application-specific processors, firmware, and any combination thereof.

In some examples, the network resource system 102 may be in communication with a content manager 130. The content manager 130 may an example of a system or device configured to manage and distribute content or media to the mobile platforms 150 for example via one or more terrestrial servers in communication with the mobile platforms 150, such as the ground terminal 110. For example, the content manager 130 may manage media stored on linear media server 104, media stored on content server 106, or both.

The content manager 130 may include or may make use of an interface, which may allow a user to manage content available on a selected subset of the mobile platforms 150. For example, the content manager 130 may provide the interface to a user, and the user may transmit a distribution request message, via the interface, to the content manager 130. The distribution request message may be for particular content, and may indicate the subset of mobile platforms 150 to which the content may be distributed. Additionally, the distribution request message may indicate a time at which the content may be scheduled to be available. For example, the distribution request message may include a scheduled time at which the user desires the content to be available on the selected mobile platforms 150.

The content manager 130 may schedule distribution of the content to the selected mobile platforms 150 using resources of a shared resource pool of the network resource system 102. The shared resource pool may include physical resources (e.g., frequency resources, time resources) used for communication across the satellite communication system 100. For example, the shared resource pool may include resources used to transmit any information or data via the satellite communication system 100, including resources for distributing content to the selected mobile platforms 150 as well as other resources used for other communications.

In some cases, the content manager 130 may identify a set of background resources for use in distributing the content to the selected mobile platforms 150. For example, the content manager 130 may determine that a beam within the range of a mobile platform 150 has excess resources within a duration of time (e.g., available resources which may not be provisioned for other traffic, resources that are in excess of resources used for traffic within a time period). The content manager 130 may provision the excess resources to transmit a portion of the content to the mobile platform 150.

Because the availability of background resources may be unpredictable, the content manager 130 may opportunistically identify available beams and background resources (e.g., on the fly) to transmit the scheduled content to the selected mobile platforms 150. For example, the content manager 130 may distribute the content to the selected mobile platforms 150 in discrete portions (e.g., piecemeal), based on available beams and background resources. Accordingly, different mobile platforms 150 of the selected mobile platforms 150 may receive different portions of the content at different times, or may receive the content out-of-order (e.g., a first mobile platform 150 may receive a first portion of the content, and may subsequently receive a second portion of the content, and a second mobile platform 150 may receive the second portion of the content and subsequently receive the first portion of the content).

Further, due to the availability of background resources, the content manager 130 may be unable to distribute the entirety of the content requested by the distribution request message by the scheduled time using background resources. In such cases, the content manager 130 may continue identifying background resources for distributing the content. If a user (e.g., a user within a mobile platform 150) requests the content after the scheduled time but before the content is available on the mobile platform 150, the content manager 130 may provision resources of the shared resource pool to stream the content to mobile platform 150. In some cases, the content manager 130 may prioritize distributing content according to the schedule time associated with the content being available. For example, if first content is associated with an earlier scheduled time than second content, the content manager 130 may prioritize allocating background resources for distributing the first content over allocating background resources for distributing the second content.

In some examples, the content manager 130 may distribute a portion of the content to multiple mobile platforms 150 using a single set of background resources. For example, if the content manager 130 determines that multiple mobile platforms 150 are capable of receiving a set of multicast packets, the content manager 130 may transmit the portion of the content to the multiple mobile platforms 150 using the multicast packets.

While a single mobile platform 150 (in this example, an airplane) is shown in communication via a single satellite 120 in FIG. 1, the techniques described herein can be applied in many other communication environments. For example, mobile platforms capable of participating in the satellite communication system 100 shown in FIG. 1 may include: aircraft (e.g., airplanes, helicopters, blimps, balloons, etc.), trains, automobiles (e.g., cars, trucks, busses, etc.), watercraft (e.g., private boats, commercial shipping vessels, cruise ships, etc.) and others. Any or all such mobile platforms may communicate via any one or more suitable communication system(s), including any suitable communication links, such as: a satellite communication system, an air-to-ground communication system, a hybrid satellite and air-to-ground communication system, a cellular communication system, and others.

Mobile platform 150 may include a two-way communication system 170 to facilitate bidirectional communication with satellite 120 via service communication link 114. Two-way communication system 170 may receive a forward link signal from satellite 120 and transmit a return link signal to satellite 120 via service communication link 114.

In the example depicted by FIG. 1, two-way communication system 170 may include a mobile terminal 158, an access point 164 (e.g., wireless access point) in communication with mobile terminal 158, one or more client devices 166 in wireless communication with access point 164, and server 162 in communication with mobile terminal 158. In some cases, the two-way communication system 170 may also include one or more client devices in communication with server 162.

The server 162 may be an example of a computing device operable to execute applications and deliver content to the one or more client devices 166 (e.g., via the mobile terminal 158). The server 162 may receive content distributed from the content manager 130. Upon receiving the content, the server 162 may store the content, for example using a non-volatile memory system. Accordingly, upon receiving a request for the content from a client device 166, the server 162 may provide the content to the client device 166, for example via the access point 164.

In some examples, a client device 166 may request content prior to the entirety of the content being available on the server 162 (e.g., after the scheduled time associated with the content, but before the entirety of the content is distributed to the mobile platform 150). In such cases, the server 162 may transmit a request to the content manager 130 for the content, or, if the server 162 has previously received and stored a portion of the content, a remaining portion of the content, and the content manager 130 may allocate resources of the shared resource pool to stream the content or the remaining portion thereof to the server 162. In some cases, the server 162 may provide the available portion of the content to the client device 166 while concurrently streaming the remaining portion from content manager 130. As part of streaming the content or remaining portion thereof, the server 162 may store the streamed content, and provide the content (e.g., the entirety of the content) to a client device 166 in the event of a subsequent request for the content.

Client devices 166 may include fixed or on-craft devices, such as passenger seat-back systems or other devices on mobile platform 150. Client devices 166 may communicate with server 162 via a communication link that may be wired or wireless, for example, as part of a local area network such as a wireless local area network (WLAN). Client devices 166 may execute one or more applications that provide an interface for users on the mobile platform 150 to obtain and consume linear media channels, as previously described. The user may have the option to select/request one or more linear media channels from the interface. When a user selects a particular linear media channel for consumption, client devices 166 may transmit a request for the selected linear media channel to server 162.

Server 162 may be configured to receive the request for the selected linear media channel from client devices 166 and forward the request to mobile terminal 158. Server 162 can provide for on-board media distribution and can include one or more media servers, media storage devices, or both. Server 162 can broker distribution of linear media channels, by managing requests for the channels from the client devices 166, and distributing the channels to the client devices 166 according to the requests. The functions of server 162 can be implemented in hardware, instructions embodied in memory and formatted to be executed by one or more general or application-specific processors of the server 162, firmware of the server 162, or any combination thereof. In the illustrated embodiment, the server 162 is shown as a separate component. In alternative embodiments, some or all of the functionality of the server 162 may be integrated into the mobile terminal 158.

Client devices 166 may include personal client devices configured to receive and display network data and that may be brought onto mobile platform 150 by passengers (e.g., mobile phones, tablets, laptop computers, etc.). Client devices 166 may execute one or more applications that provide an interface for users to obtain and consume network data, as previously described. The user may have the option to select/request network content for viewing from the interface. When a user interacts with client devices 166, the client devices 166 may transmit a request for the selected network content to a mobile terminal 158 via access point 164. Client devices 166 are also configured to receive the requested network content from the mobile terminal 158 via access point 164. Access point 164 is configured to provide communication between mobile terminal 158 and client devices 166.

Mobile terminal 158 may be configured to receive the request(s) for the selected linear media channel(s) from server 162 and multiplex and forward them to a linear media server. Mobile terminal 158 may also be configured to receive and demultiplex linear media channel packets associated with the selected linear media channel from modem and forward them to server 162.

Mobile terminal 158 may further be configured to receive the requests for the selected network content from client devices 166 via access point 164 and multiplex and forward them to a destination (e.g., Internet 108). Mobile terminal 158 may also be configured to receive and demultiplex network traffic packets associated with the selected network content and forward them to client devices 166 via access point 164.

The mobile terminal 158 may receive previously described requests, indications and any other data using a modem, and may generate modulated data (e.g., a transmit intermediate frequency (IF) signal) for delivery to a transceiver. The modem may additionally receive the requested linear media channel data and requested network data as a modulated data (e.g., a receive intermediate frequency (IF) signal) from the transceiver and demodulate that data for transmission to mobile terminal 158. In some embodiments, the modem may be integrated with the mobile terminal 158, while in others the modem may be a separate component.

Mobile terminal 158 may up-convert and amplify the modulated data to generate a return link signal of the service communication link 114 for transmission to satellite 120 via an antenna system. Similarly, mobile terminal 158 may receive the forward link signal of the service communication link 114 from satellite 120 via the antenna system. Mobile terminal 158 may then amplify and down-convert the forward link signal to generate modulated downlink data (e.g., a receive IF signal) for demodulation.

Although the above description details certain client devices 166 communicating with server 162 to request and receive linear media channels, and other client devices 166 communicating with the mobile terminal 158 to request and receive network data, the present application also contemplates that client devices 166 could also request and receive network data, and that client devices 166 could also request and receive linear media channel data. In such embodiments, each of server 162 and mobile terminal 158 may further include functionality of the other as previously described in order to support such requesting and receiving configurations of client devices 166. The functions of each of server 162 and mobile terminal 158 can be implemented in hardware, instructions embodied in a memory and formatted to be executed by one or more general or application-specific processors, firmware, or any combination thereof.

FIG. 2 illustrates an example of a system 200 that supports interfaces for aircraft servers in accordance with aspects of the present disclosure. The system 200 may include an on-ground media server 230, which may be included in or in communication with the content manager 130. The on-ground media server 230 may comprise control circuitry 231, which may be used to determine or acquire information relating to what media content of the media content items 251 (e.g., on-ground content library) is to be added to a particular mobile platform (e.g., the mobile platform 150 of the system 100).

The control circuitry 231 (e.g., the data transfer package generator and/or rules engine 232) of the on-ground media server 230 may be configured to determine a subset of the media content items 251 that is associated with a particular mobile platform (e.g., vehicle or aircraft) based on content access rule data 259. That is, the data transfer package 203 may represent a subset of the media content items 251 that is accessible or scheduled for transfer to one or more mobile platforms, as indicated by the content access rule data 259. For airplane mobile platform embodiments, the parameters of the content access rule data 259 may be directed by an airline associated with the airplane mobile platform. With respect to one or more media content items of the media content items 251, no license may be required for use or presentation thereof. For example, some content may be free, or open-source, content that is not subject to licensing rules. Such free access to the content may be indicated by the content access rule data 259. Other content may be subject to licensing rules, which may be indicated by the content access rule data 259. The control circuitry 231 may manage distribution of the content based on the content access rule data 259. Although the data transfer package 203 is described as being a subset of the media content items 251, in some embodiments, the media content that is transferred in the data transfer package 203 may comprise the entire library of media content items 251.

The network 222 may comprise a wide area network, such as the Internet 108, which may be accessed by a mobile platform via a communication network 208. Therefore, the communication link between the on-ground media server 230 and a remote mobile platform 150-a may be achieved over the wide area network (e.g., the Internet) and the communication network 208. In some embodiments, transmission of the data transfer package 203 to a mobile platform via an external communication link, such as a satellite network connection, may compete with other data transfer needs of the communication network using resources of a shared resource pool, which may experience fluctuations in demand that may exceed a capacity of the shared resource pool. For example, such other data transfer demands may involve requests for data from passengers currently onboard the vehicle or aircraft, as well as requests for data from other mobile platforms and fixed terminals. In certain embodiments, the on-ground media server 230 may be configured to implement the transmission of the data transfer package 203 to a mobile platform during a period of time in which the network used by the mobile platform has available background resources, such as sufficient or unused network capacity or bandwidth, thereby improving efficiency and utilization of available resources of the shared resource pool. Furthermore, in some implementations, the data transfer package 203 may be transmitted from the on-ground media server 230 to the relevant mobile platform using background resources as part of a “trickle” data transfer process or capability, which may utilize unused capacity of a network when such capacity may otherwise be idle, and therefore the impact on network bandwidth may be negligible or reduced. For example, a trickle transfer process may be implemented that transfers data only when capacity is available after traffic that has a real-time demand or time-sensitive consumption characteristic has been transmitted. In such a case, the transmission of the data transfer package 203 may be a lower priority than other traffic delivered via a wireless communication link or other network connection. In contrast, the real-time transfer of media content items via the communication network may be according to a higher priority than the data transfer package. In some cases, priorities may be applied between content items sent using background resources based on time to availability of the content items.

The system 200 may provide a centralized ground-based system for managing the distribution of a variety of different types of content items to the mobile platform 150. In some solutions, metadata and/or content access rule data associated with different types of content items may be handled and/or synchronized separately through separate on-ground media servers or systems. For example, on-demand video content may be managed by a separate on-ground server than broadcast television content or other types of content items.

As referenced above in connection with the system 100, embodiments of the present disclosure may provide for the distribution of content items from content sources and transmission of such content items and/or associated content access rule data in one or more data transfer packages. In some embodiments, the on-ground media server 230 may support an interface 205, which may be provided to operators of one or more content sources 240. The interface 205 may allow the operators to generate and issue a distribution request message 207 associated with content from the one or more content sources 240. The distribution request message 207 may include metadata associated with the content. Such metadata may include various parameters relating to content access rules associated with the content items. For example, the parameters may include an indication of particular mobile platforms on which the content is to be available. Additionally, the parameters may include an indication of a scheduled time (e.g., an availability time) at which the content is be available on the indicated mobile platforms. In some embodiments, the content sources 240 further provide the content items themselves to the on-ground media server 230 via the network 222. The on-ground media server 230 may store the media content items received from various content sources in data storage 250, which may comprise one or more magnetic, optical, solid-state, and/or other types of data storage media. The on-ground media server 230 may further utilize the control circuitry 231, and in particular the data transfer package generator 236 and rules engine 232, to provide a ground-based system to manage distribution of content items to a selection of mobile platforms and servers associated therewith.

The rules engine 232 is configured to apply content access rule data to content items and/or associated metadata to determine accessibility of content items for transmission to and/or presentation on a mobile platform (e.g., airplane). The determination of accessibility of a content item or group of content items in view of content access rule data, whether based on authorization to view content or other considerations, may be referred to herein as “rules resolution.” The rules engine 232 may be configured to resolve the content access rule data 259 and map the content access rule data to individual media content items, or groupings thereof, of the media content items 251. The content access rule data 259 may indicate whether individual content access items or groups of content items are accessible to an end user on a mobile platform based on one or more parameters. For example, the content access rules may indicate that a particular content item or group of content items is accessible or inaccessible when one or more mobile platform status parameters have certain value(s). Additionally or alternatively, the content access rule data 259 may indicate particular parameter values associated with content accessibility and/or inaccessibility, either alone or in combination. For example, the content access rules may indicate that content items associated with certain parameter value(s) for a certain parameter type are accessible or inaccessible or should be transferred in the data transfer package to one or more mobile platforms.

As referenced above, the data transfer package generator 236 may be configured to compile a subset of the media content items 251 for inclusion in a data transfer package 203 intended for a particular mobile platform, or group of mobile platforms. In some embodiments, the data transfer package generator 236 is configured to determine a superset of media content items that may be accessible on the given mobile platform under certain conditions, wherein at any given time, only a subset of the superset of media content items may be accessible for presentation to end-users. That is, the on-ground media server 230 may provide a library of media content items to a mobile platform, wherein the library is potentially larger than the current library of accessible content items for presentation at a given time. Such a packaging of a superset of media content items in the data transfer package 203 may advantageously allow for the mobile platform to implement local rules resolution and provide varying content accessibility across changing conditions. Such local rules resolution may be based at least in part on mobile platform status parameter values, which may be accessible on one or more communication busses of the mobile platform. In some embodiments, the content access rule data 259, or at least a subset thereof, and the media content items 251 or subset thereof may be synchronized to the mobile platform by the control circuitry 231.

The content access rule data 259 defines access rules for individual content items 258 and/or groups of content items. For example, groups of content items may have similar access rules, and therefore may be resolved collectively in some embodiments. The access rules indicate what content items or groups of content items are authorized or intended for presentation at the mobile platform, or otherwise accessible for presentation by the mobile platform. The access rules may generally relate to one or more parameters (e.g. Param A, Param B) relating to conditions, characteristics, and/or statuses under which a given content item or group of content items is authorized or accessible. The parameters may be content parameters and/or mobile platform status parameters, as described herein. For example, parameters may be associated with one or more of trip destination, trip origin, physical location, mobile platform type, mobile platform passenger demographic, or the like. In some embodiments, at least some of the access rules are not content-item-specific, and rather indicate content parameter values and/or mobile platform status parameter values that are associated with accessible or inaccessible content. For example, the rules engine 232 may determine a subset of the media content items 251 that have content parameter values that indicate accessibility according to the content access rule data and/or mobile platform status parameter values associated with a mobile platform, wherein the data transfer package generator 236 may be configured to compile such content items in the data transfer package 203 and transmit the data transfer package 203 to the mobile platform.

Parameter data for a given content item, including content parameter-value pair data, may be provided to the on-ground media server 230 as metadata 201 and may be provided from a variety of content sources 240. As described above, content parameters of the parameter data 202 can be content-specific. For example, for a given content item (e.g., Item 1), metadata associated therewith may include one or more parameters (e.g. Param A, Param B, referring to parameter types paired with corresponding parameter values for the content item(s)) relating to accessibility of the content item. The parameter data may include a value for each parameter that is associated with the given content item or group of content items. For example, as referenced above, the metadata 201 may comprise key-value pairs for each parameter and each content item. Generally, as understood by those of ordinary skill in the art, a key-value pair may generally link data items, namely a key or identifier (e.g., a parameter type, such as content title, accessibility start time, etc.) and a value. With respect to embodiments disclosed herein, key-value pairs may be understood to be parameter-value pairs. A set of parameter-value pairs may be assigned for each content item. For example, the metadata 201 may comprise a data structure for each content item, wherein the data structure includes parameter-value pairs for each relevant parameter. As an example, in the context of an airplane mobile platform, metadata may comprise parameter-value pairs for a plurality of content items and/or groupings of content items. For example, the parameters of the metadata may include values for each parameter that indicate accessibility conditions for the respective content item(s). For example, a given content item may have parameter values for one or more of an airplane identifier, flight origin, flight destination, geographic location, or the like, wherein the values associated with the parameters indicate the airplane identifiers, flight origins, flight destinations, and/or geographic locations that correspond to accessibility or inaccessibility of the respective content item(s).

Additional examples of content parameters for content access rules include, but are not limited to, content accessibility/availability start time or date, end time or date, content genre, title, actors, thumbnail graphics, and/or any other parameter(s) or attribute(s) specific to a content item that is desirable to provide to the on-ground media server 230 for the purpose of rules resolution. For example, with respect to advertisement content items, such content items may generally be associated with validity start and end time or date parameters, as well as one or more marketing parameters, such as intended age and/or gender demographic parameters, as well as geography parameters.

The on-ground media server 230 may provide a single source for content access rule data and content items. Provisioning of the content access rule data 259 and media content items 251 as one or more data transfer packages may be achieved through any suitable or desirable mechanism. For example, the data transfer package may be transmitted using a pull methodology, which may leverage media interface circuitry of the mobile platform. Further, the data transfer package may be transmitted to the mobile platform using a communication network, such as a ground terminal 110 and satellite 120, in conjunction with a distributed content delivery network (CDN). Once downloaded or installed at the mobile platform, the mobile platform may be able to provide access to the media content items with or without connectivity with the on-ground media server 230.

The content access rule data 259 may further include priority parameter data, which may allow for one access rule or grouping of access rules to take precedence over another. The content parameter values associated with a content item may constitute input that is resolved by the rules engine 232 to determine accessibility. The content access rule data 259 may further include mobile platform status parameters, which may at least partially determine the content items that resolve as accessible at a given point in time. Access rules for content items sourced from different content sources can be combined by the adapters 234 into a common data format, such as a JSON format, or simplified JSON format. For example, the content items 258 identified in the content access rule data 259 may include different types of content together in a single data structure. The on-ground media server 230 may interface with an application programing interface (API) of a content source to pull the metadata 201 from the content source, wherein adapter circuitry that is specific to the particular content source may be utilized to parse or otherwise interpret the metadata to reformat the parameter data 202 to a common data format.

With respect to the management of metadata by the on-ground media server 230 from a plurality of distinct content sources, such distinct content sources may utilize different APIs with which the adapters 234 are configured to interface. Such APIs may be utilized by the on-ground media server 230 to request and/or acquire desired metadata from the respective content sources. As the metadata from the various content sources may be received in various data formats, the adapters 234 are advantageously configured to reformat such metadata to a common data format to compile and build the content access rule data 259. The adapters 234 are configured to translate the different packages of metadata to a common data format centrally, such that the parameters thereof can be managed with a singular tool (e.g., rules engine 232).

The on-ground media server 230 further comprises graphical interface data generation circuitry 235, which may be configured to generate graphical interface data for rendering graphical interfaces to allow for configurability of the content access rule data 259, as applicable to one or more content items of the media content items 251. Furthermore, the graphical interface data generation circuitry 235 may further be configured to generate data for rendering graphical interfaces for use by mobile platforms in communications with the on-ground media server relating to data transfer packages and/or content access rule data.

The data transfer package generator 236 may be configured to compile media content items and/or associated content access rule data for a plurality of passenger services for a mobile platform. That is, the data transfer package 203 may comprise different types of media content in a single package. In some embodiments, the data transfer package 203 generated by the data transfer package generator 236 may comprise a set or collection of media content items and/or content access rules that is designed to be resolved locally on the mobile platform, such that the mobile platform may resolve content access rules locally and determine what content items are accessible to passengers. That is, the data transfer package 203 may comprise a superset of media content items, such that the mobile platform may select among the superset of media content items. To such end, the data transfer package generator 236 may be configured to apply relatively broader selection criteria for media content items than the mobile platform. The mobile platform may in turn resolve the various current mobile platform status parameter values and/or content parameter values, such as geography, time, route, genre, or the like locally to determine a subset of accessible content items from among the superset of content items contained in the data transfer package 203. In some embodiments, the data transfer package 203 is an update package. That is, the mobile platform may store locally a media content library on an associated server, wherein the data transfer package 203 comprises an update of media content items to supplement the locally maintained media content library at the mobile platform. The data transfer package 203 may include product catalog content items, such as in-flight connectivity service offerings for a flight, or the like. Content access rules may be applied to such content to determine relevant or desired prices associated with the connectivity services.

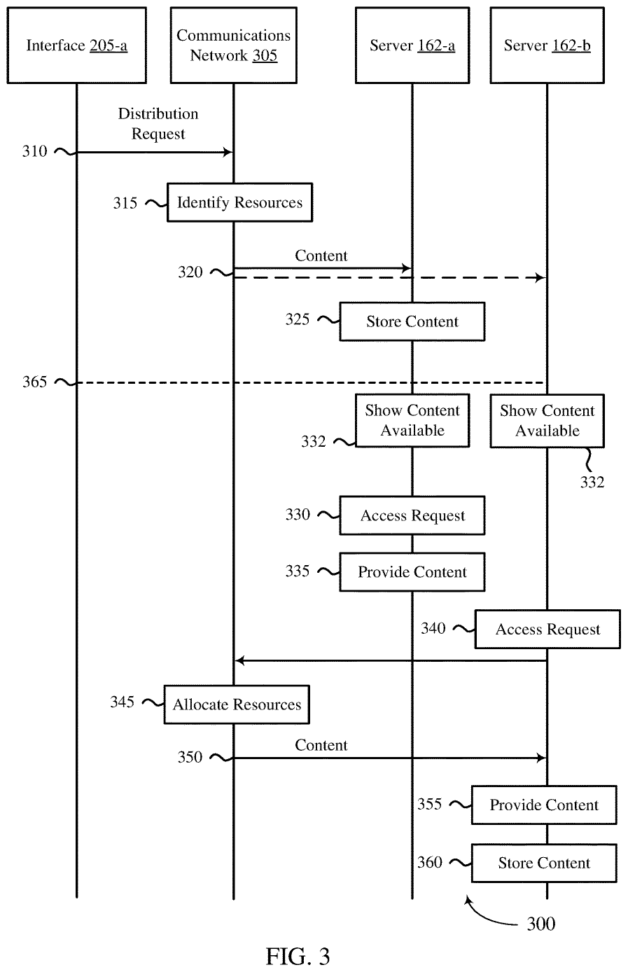

FIG. 3 illustrates an example of a process flow 300 that supports interfaces for aircraft servers in accordance with aspects of the present disclosure. In some examples, process flow 300 may be implemented by aspects of the systems 100 and 200. For example, the process flow 300 may include operations performed by a communication network 305 and one or more servers, such as a server 162-a and a server 162-b, which may be examples of the corresponding devices as described with reference to FIGS. 1 and 2. In some cases, the server 162-a and the server 162-b may each be a server of a respective mobile platforms 150 (e.g., via respective mobile terminals). The server 162-a and the server 162-b may be configured to communicate with a content manager 130 using communication links of the communication network 305. The content manager 130 may include or may make use of an interface 205-a. The communication network 305 may include both ground-based and aerial components, such as the content manager 130, a network resource system 102, a ground terminal 110, a satellite 120, or a combination thereof. In the following description of the process flow 300, the operations may be performed in a different order than the order shown. For example, specific operations may also be left out of the process flow 300, or other operations may be added to process flow 300.

The process flow 300 may illustrate a process to distribute content (e.g., entertainment content, informational content) to the server 162-a, the server 162-b or both. At 310, the interface 205-a may transmit a distribution request to the communication network 305. For example, the content manager 130 may provide the interface 205-a to a user (e.g., a manager of the content), and the interface 205-a may allow the user to select one or more servers of respective mobile platforms on which the user would like the content to be available, as well as select a scheduled time 365 at which the user would like the content to be available on the servers. The distribution request message may instruct the communication network 305 to distribute particular content to the one or more servers of the respective mobile platforms in communication with the communication network 305.

The distribution request may include one or more parameters for distributing the content. For example, the one or more parameters may include an indication of the selected set of mobile platforms (e.g., a set of servers on the mobile platforms) to which to deliver the content. The one or more parameters may indicate to distribute the content to each mobile platform in communication with the communication network 305, or may indicate to distribute the content to a subset of the mobile platforms in communication with the communication network 305. In the example illustrated in process flow 300, the one or more parameters may indicate to distribute the content to at least the server 162-a and the server 162-b, although the example is not limited to two servers, and may include any quantity of servers.

Additionally, the one or more parameters may indicate the selected scheduled time 365 at which the content may be scheduled to be available on the server 162-a, the server 162-b, or both. Because a selection of a relatively large quantity of servers, an earlier scheduled time, or both may be associated with greater overhead, such as a greater quantity of communication resources used to distribute the content, a higher priority of the associated content, or both, a price associated with the distribution request may be commensurate with the selected parameters (e.g., availability of the content at an earlier time may cost more than a later time).

At 315, the communication network 305 may identify resources to distribute the content to the server 162-a and the server 162-b. For example, the communication network may search within a shared resource pool (e.g., a shared resource pool of the network resource system 102) for background resources with which to transmit at least portions of the content to the server 162-a, the server 162-b, or both, as described in greater detail with reference to FIG. 1. Accordingly, at 320, the communication network may transmit the content, or portions thereof, to the server 162-a.

In some cases, as part of identifying the resources at 315, the communication network 305 may determine that both the server 162-a and the server 162-b are within a same transmission beam, or are otherwise capable of receiving a same set of multicast packets of the shared resource pool. In such cases, the communication network 305 may, at 320, transmit the content or portions thereof to the server 162-a and the server 162-b using the multicast packets. Alternatively, the communication network 305 may use different background resources (e.g., of a different beam) to transmit the content to the server 162-b. In some cases, background resources of a beam serving server 162-b may not be available, and the content may not be transmitted to server 162-b at 320.

At 325, the server 162-a may, after receiving the content from the communication network 305 and before the scheduled time 365, store the content. In some cases, the server 162-a may store the content in a persistent (e.g., non-volatile) memory system coupled with the server 162-a. Although not shown, the server 162-b may also, if it received the content at 320, store the content at 325.

At 332, the servers 162-a and 162-b may indicate the content as being available based on a current time being the same or subsequent to the scheduled time 365. For example, even if the server 162-b has not received the content at 320, it may still show the content as being available to client devices on the mobile platform after the scheduled time 365. Subsequently, at 330, a client device within the mobile platform associated with the server 162-a may issue a request for the content, and the server 162-a may, at 335, provide the content to the client device.

As described above, the communication network 305 may not distribute the content to both the server 162-a and the server 162-b within the scheduled time 365. For example, because the communication network 305 may opportunistically identify and allocate background resources (e.g., may allocate background resources on-the-fly), the communication network 305 may not identify sufficient background resources to distribute the entirety of the content to the server 162-b prior to the scheduled time 365. In such cases, the communication network 305 may continue identifying background resources to distribute the content. However, at 340 (e.g., after the scheduled time 365 for which the content was scheduled to be available), a client device of a mobile platform associated with the server 162-b may issue an access request for the content (e.g., based on the indication at 332 that the content is available).

In such cases, the server 162-b may transmit a request to the communication network 305 for the content, or, if the server 162-b has previously received and stored a portion of the content (e.g., at 320), a remaining portion of the content. In response to the request, at 345, the communication network 305 may allocate resources of the shared resource pool to stream the content or the remaining portion thereof to the server 162-b, and may, at 350, transmit the content to the server 162-b. Upon receiving the content, at 355, the server 162-b may provide the content to the client device.

In some cases, the server 162-b may provide the available portion of the content to the client device while concurrently streaming the remaining portion from the communication network 305. As part of streaming the content or remaining portion thereof, the server 162-b may, at 360, store the streamed content (e.g., in a persistent memory system coupled with the server 162-b), such that the server 162-b may provide the content (e.g., the entirety of the content) to a client device in the event of a subsequent request for the content.

In some cases, priority of content items for use of background resources may depend on a current time and respective scheduled availability times for the content items. The respective priorities may be determined by time remaining to the respective scheduled availability times and one or more thresholds. For example, a first content item may be scheduled to be available in 72 hours on a mobile platform and may be given a first priority based on the time to availability being greater than a first threshold. Subsequently, when the time remaining to the scheduled availability time (e.g., 48 hours) reaches the first threshold, the priority for the first content item may be raised from the first priority to a second, higher priority. If more time elapses without the content being distributed to the intended server on a mobile platform and the time to availability goes below a second threshold (e.g., 24 hours), the priority for the content may be raised from the second priority to a third priority that is higher than the second priority.

Additional priorities and thresholds may be defined for use of background resources. Thus, management of resources (e.g., time-frequency resources, beams) that are background or not used for real-time traffic may be managed according to the priorities. For example, for a given beam of a satellite communications system, when background resources (e.g., resources not used for real-time or time-sensitive traffic) are identified, they are first allocated to any pending content items having the highest priority for background resources, then to pending content items have the next highest priority, and so on. Thus, background resources may first be used for communication of content items that have the lowest time to availability. However, each of the priorities for communicating the content items using background resources may be lower than the priorities of real-time or time-sensitive content. For example, traffic based on user requests for available content and other user requests (e.g., streaming media, web pages) may have higher priority than the highest priority for use of the background resources. That is, the priorities for background resources may only be applied when background resources are available after resources are allocated for all pending or queued real-time or time-sensitive traffic.

In some cases, in addition to or in the alternative to time to availability of a content item, the priority may also be based on whether a portion of the content has been communicated. For example, priority (e.g., within a given priority level based on time to availability if in addition to time to availability) may be given to content items having the least portions of the content that have been communicated. Getting at least a portion of each content item may be beneficial because it may reduce the data transfer rate for the remaining portion of the content item. For example, if a portion of the content item has been provided to server 162-b at 320, the communication network 305 may transfer a remaining portion at a lower rate than a full streaming rate of the content item. For example, if a streaming content rate (to stream in real-time) for a content item is 5 Mbps and at least a portion of the content was communicated at 320, the communication network 305 may transfer a remaining portion at a lower rate (e.g., less than 5 Mbps) at 350 while the content that has already been communicated is being sent from the server 162-b to the client device.

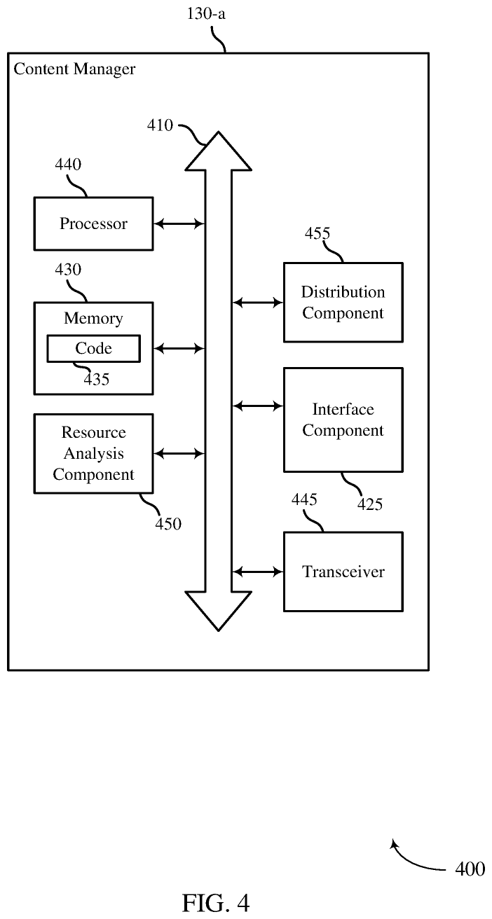

FIG. 4 shows a block diagram 400 of a content manager 130-a that supports interfaces for aircraft servers in accordance with aspects of the present disclosure. The content manager 130-a may be an example of aspects of a satellite communications system 100 as described with reference to FIG. 1. The content manager 130-a, or various components thereof, may be an example of means for performing various aspects of interfaces for aircraft servers as described herein. For example, the content manager 130-a may include an interface component 425, a distribution component 455, a resource analysis component 450, a processor 440, a bus 410, memory 430 storing code 435, a transceiver 445, or any combination thereof. Each of these components may communicate, directly or indirectly, with one another (e.g., via one or more buses).

The interface component 425 may be configured as or otherwise support a means for providing an interface associated with content distribution to respective servers on a plurality of mobile platforms, wherein the respective servers are coupled with a communication network via respective communication links established with the plurality of mobile platforms, wherein the respective communication links use a shared resource pool. The transceiver 445 may be configured as or otherwise support a means for receiving, via the interface, a distribution request message for first content for distribution to at least a subset of the plurality of mobile platforms, the distribution request message comprising a plurality of distribution parameters. The distribution component 455 may be configured as or otherwise support a means for distributing the first content to the at least the subset of the plurality of mobile platforms, wherein the distributing comprises determining resources of the respective communication links for distribution of the first content based at least in part on the plurality of distribution parameters and utilization of the shared resource pool.

In some examples, the plurality of distribution parameters comprises an indication of the at least the subset of the plurality of mobile platforms.

In some examples, the plurality of distribution parameters comprises a time associated with the first content being available on the at least the subset of the plurality of mobile platforms.

In some examples, to support distributing the first content to the at least the subset of the plurality of mobile platforms, the transceiver 445 may be configured as or otherwise support a means for transmitting, based at least in part on utilization of the shared resource pool and before the time, the first content from a terrestrial server of the communication network to the at least the subset of the plurality of mobile platforms via the respective communication links.

In some examples, to support distributing the first content to the at least the subset of the plurality of mobile platforms, the transceiver 445 may be configured as or otherwise support a means for transmitting, based at least in part on utilization of the shared resource pool and after the time, the first content from a terrestrial server of the communication network to the at least the subset of the plurality of mobile platforms.

In some examples, to support distributing the first content to the at least the subset of the plurality of mobile platforms, the resource analysis component 450 may be configured as or otherwise support a means for determining that a beam associated with a mobile platform of the at least the subset of the plurality of mobile platforms has resources that are in excess of resources used for traffic for a time period. In some examples, to support distributing the first content to the at least the subset of the plurality of mobile platforms, the transceiver 445 may be configured as or otherwise support a means for transmitting at least a portion of the first content to the mobile platform via the beam using the resources during the time period.

In some examples, to support transmitting the first content to the mobile platform, the transceiver 445 may be configured as or otherwise support a means for transmitting, via the communication network, the at least the portion of the first content to two or more of the at least the subset of the plurality of mobile platforms via a set of multicast packets.

In some examples, the resource analysis component 450 may be configured as or otherwise support a means for determining that a second beam associated with the mobile platform has resources that are in excess of resources used for traffic for a second time period. In some examples, the transceiver 445 may be configured as or otherwise support a means for transmitting at least a second portion of the first content to the mobile platform via the second beam during the second time period.

In some examples, the resource analysis component 450 may be configured as or otherwise support a means for assigning a first priority for utilization of the shared resource pool to the first content and a second priority for utilization of the shared resource pool to second content for distribution to the at least the subset of the plurality of mobile platforms, the first priority higher than the second priority, based at least in part on a first time associated with the first content being available being before a second time associated with the second content being available.

In some examples, the resource analysis component 450 may be configured as or otherwise support a means for allocating, based at least in part on determining that at least a portion of the second content is not stored in the respective server, a set of resources of the shared resource pool for streaming the at least the portion of the second content. In some examples, the distribution component 455 may be configured as or otherwise support a means for streaming, based at least in part allocating the set of resources, the at least the portion of the second content to the device.

In some examples, the distribution component 455 may be configured as or otherwise support a means for providing the first portion of the second content to the device. In some examples, the transceiver 445 may be configured as or otherwise support a means for transmitting, via the communication network, the second portion of the second content to the respective server of the mobile platform, wherein transmitting the second portion of the second content overlaps at least partially in time with providing the first portion of the second content.

Bus 410 may represent an interface over which signals may be exchanged between components of content manager 130-a and a location (e.g., a central location) that may be used to distribute the signals to a signal processing components of content manager 130-a (e.g., transceiver 445). Bus 410 may one or more wired interfaces. Additionally, or alternatively, bus 410 may be a wireless interface that is used to wirelessly communicate signaling between the signal processing components—e.g., in accordance with a communication protocol.

The memory 430 may include volatile memory (e.g., RAM) and/or nonvolatile memory (e.g., ROM). Other types of memory may also be possible. The memory 430 may store code 435 that is computer-readable and computer-executable. The code may include instructions that, when executed by the processor 440, cause the content manager 130-a to perform various functions described herein. The code 435 may be stored in a non-transitory computer-readable medium such as system memory or another type of memory. In some cases, the code 435 may not be directly executable by the processor 440 but may cause a computer (e.g., when compiled and executed) to perform functions described herein. In some cases, the memory 430 may contain, among other things, a BIOS which may control basic hardware or software operation such as the interaction with peripheral components or devices.

Processor 440 may include an intelligent hardware device (e.g., a general-purpose processor, a DSP, a CPU, a microcontroller, an ASIC, a field programmable gate array (FPGA), an PLD, a discrete gate or transistor logic component, a discrete hardware component, or any combination thereof). The processor 440 may be configured to execute computer-readable instructions stored in a memory (e.g., memory 430) to cause the content manager 130-a to perform various functions (e.g., functions or tasks supporting aircraft server containerization). For example, the content manager 130-a or a component of the content manager 130-a may include a processor 440 and memory 430 coupled to the processor 440 that are configured to perform various functions described herein.

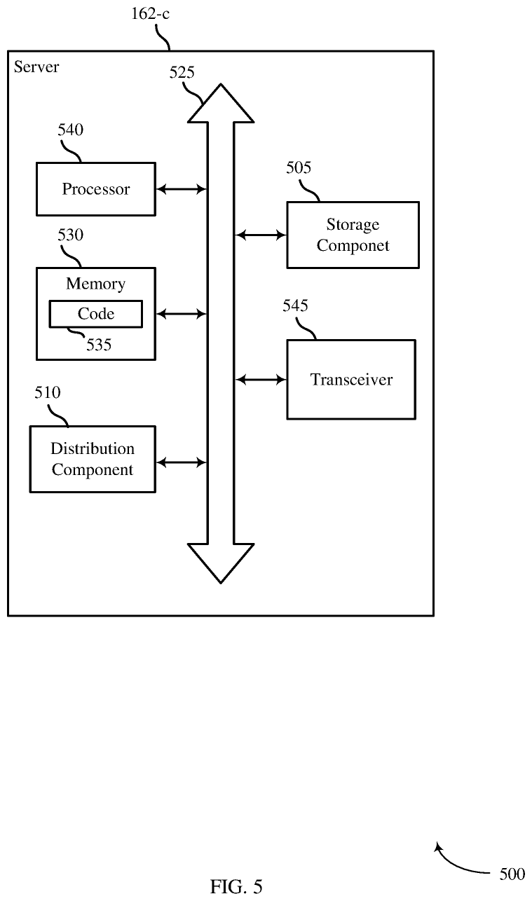

FIG. 5 shows a diagram of a block diagram 500 including a server 162-c that supports interfaces for aircraft servers in accordance with aspects of the present disclosure. The server 162-c may be an example of aspects of a satellite communication system 100 as described with reference to FIG. The server 162-c, or various components thereof, may be an example of means for performing various aspects of interfaces for aircraft servers as described herein. For example, the server 162-c may include a storage component 505, a distribution component 510, code 535 stored in memory 530, a processor 540, a bus 525, and a transceiver 545. Each of these components may communicate, directly or indirectly, with one another.

In some examples, to support distributing the first content to the at least the subset of the plurality of mobile platforms, the storage component 505 may be configured as or otherwise support a means for storing first content received from the content manager 130-a via the transceiver 545 in respective non-volatile memory devices of the respective servers.

In some examples, to support distributing the first content to the at least the subset of the plurality of mobile platforms, the storage component 505 may be configured as or otherwise support a means for storing the first content in respective non-volatile memory devices of the respective servers.

In some examples, the distribution component 510 may be configured as or otherwise support a means for receiving, after a second time associated with second content being available on the at least the subset of the plurality of mobile platforms, an access request for the second content from a device within a mobile platform of the at least the subset of the plurality of mobile platforms. In some examples, the storage component 505 may be configured as or otherwise support a means for determining whether the second content is stored on the respective server of the mobile platform based at least in part on the access request.

In some examples, the distribution component 510 may be configured as or otherwise support a means for providing, based at least in part on determining that at least a portion of the second content is stored in the respective server, the at least the portion of the second content to the device.

In some examples, the storage component 505 may be configured as or otherwise support a means for storing the at least the portion of the second content on the respective server of the mobile platform based at least in part on streaming the at least the portion of the second content.

In some examples, the storage component 505 may be configured as or otherwise support a means for determining that a first portion of the second content is stored on the respective server of the mobile platform and a second portion of the second content is not stored on the respective server of the mobile platform.

Bus 525 may represent an interface over which signals may be exchanged between components the server 162-c and a location (e.g., a central location) that may be used to distribute the signals to the signal processing components of the server 162-c (e.g., transceiver 545). Bus 525 may one or more wired interfaces. Additionally, or alternatively, bus 525 may be a wireless interface that is used to wirelessly communicate signaling between the signal processing components—e.g., in accordance with a communication protocol.

The memory 530 may include volatile memory (e.g., RAM) and/or nonvolatile memory (e.g., ROM). Other types of memory may also be possible. The memory 530 may store code 535 that is computer-readable and computer-executable. The code may include instructions that, when executed by the processor 540, cause the server 162-c to perform various functions described herein. The code 535 may be stored in a non-transitory computer-readable medium such as system memory or another type of memory. In some cases, the code 535 may not be directly executable by the processor 540 but may cause a computer (e.g., when compiled and executed) to perform functions described herein. In some cases, the memory 530 may contain, among other things, a BIOS which may control basic hardware or software operation such as the interaction with peripheral components or devices.

Processor 540 may include an intelligent hardware device (e.g., a general-purpose processor, a DSP, a CPU, a microcontroller, an ASIC, a field programmable gate array (FPGA), an PLD, a discrete gate or transistor logic component, a discrete hardware component, or any combination thereof). The processor 540 may be configured to execute computer-readable instructions stored in a memory (e.g., memory 530) to cause the server 162-c to perform various functions (e.g., functions or tasks supporting aircraft server containerization). For example, the server 162-c or a component of the server 162-c may include a processor 540 and memory 530 coupled to the processor 540 that are configured to perform various functions described herein.

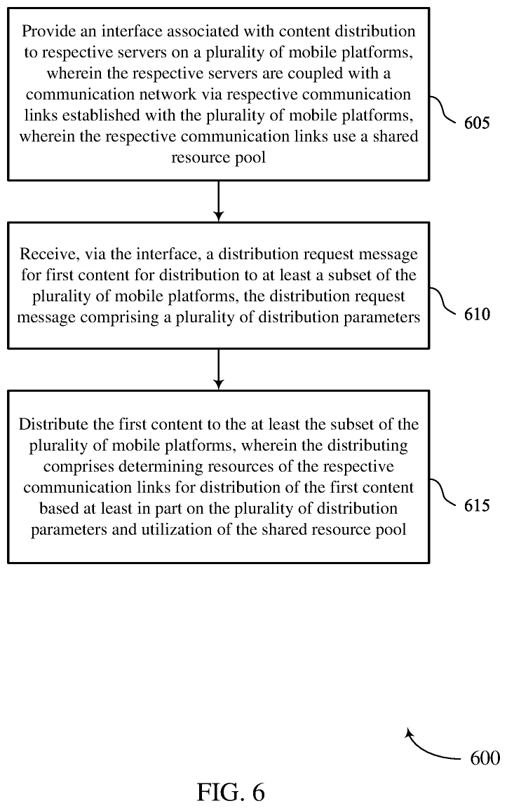

FIG. 6 shows a flowchart illustrating a method 600 that supports interfaces for aircraft servers in accordance with aspects of the present disclosure. The operations of the method 600 may be implemented by a satellite communications system or its components as described herein. For example, the operations of the method 600 may be performed by a satellite communications system as described with reference to FIGS. 1 through 5. In some examples, a satellite communications system may execute a set of instructions to control the functional elements of the satellite communications system to perform the described functions. Additionally, or alternatively, the satellite communications system may perform aspects of the described functions using special-purpose hardware.

At 605, the method may include providing an interface associated with content distribution to respective servers on a plurality of mobile platforms, wherein the respective servers are coupled with a communication network via respective communication links established with the plurality of mobile platforms, wherein the respective communication links use a shared resource pool. The operations of 605 may be performed in accordance with examples as disclosed herein. In some examples, aspects of the operations of 605 may be performed by an interface component 425 as described with reference to FIG. 4.

At 610, the method may include receiving, via the interface, a distribution request message for first content for distribution to at least a subset of the plurality of mobile platforms, the distribution request message comprising a plurality of distribution parameters. The operations of 610 may be performed in accordance with examples as disclosed herein. In some examples, aspects of the operations of 610 may be performed by a interface component 425 as described with reference to FIG. 4.

At 615, the method may include distributing the first content to the at least the subset of the plurality of mobile platforms, wherein the distributing comprises determining resources of the respective communication links for distribution of the first content based at least in part on the plurality of distribution parameters and utilization of the shared resource pool. The operations of 615 may be performed in accordance with examples as disclosed herein. In some examples, aspects of the operations of 615 may be performed by a distribution component 455 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer readable media includes both non transitory computer storage media and communication media including any medium that facilitates transfer of a computer program from one place to another. A non-transitory storage medium may be any available medium that can be accessed by a general purpose or special purpose computer. By way of example, and not limitation, non-transitory computer readable media may include RAM, ROM, electrically erasable programmable read-only memory (EEPROM), flash memory, compact disk read-only memory (CDROM) or other optical disk storage, magnetic disk storage or other magnetic storage devices, or any other non-transitory medium that can be used to carry or store desired program code means in the form of instructions or data structures and that can be accessed by a general purpose or special purpose computer, or a general purpose or special purpose processor. Also, any connection is properly termed a computer readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu ray disc where disks usually reproduce data magnetically, while discs reproduce data optically with lasers. Combinations of the above are also included within the scope of computer readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method, comprising:
providing an interface that enables distribution of content to respective servers on a plurality of mobile platforms, the content comprising entertainment content or information content to provide to devices within the plurality of mobile platforms, wherein the respective servers are coupled with a communication network via respective communication links established with the plurality of mobile platforms, wherein the respective communication links use a shared resource pool;
receiving, via the interface, a distribution request message for first content for distribution to at least a subset of the plurality of mobile platforms, the distribution request message comprising a plurality of distribution parameters, the plurality of distribution parameters comprising an indication of the at least the subset of the plurality of mobile platforms, a time at which the first content is scheduled to be available on the at least the subset of the plurality of mobile platforms, or both, wherein the at least the subset comprises two or more mobile platforms of the plurality of mobile platforms; and
distributing the first content to the at least the subset of the plurality of mobile platforms, wherein the distributing comprises determining resources of the respective communication links for distribution of the first content based at least in part on the plurality of distribution parameters and utilization of the shared resource pool.

2. The method of claim 1, wherein the plurality of distribution parameters comprises the indication of the at least the subset of the plurality of mobile platforms.

3. The method of claim 1, wherein the plurality of distribution parameters comprises the time at which the first content is scheduled to be available on the at least the subset of the plurality of mobile platforms.

4. The method of claim 3, wherein distributing the first content to the at least the subset of the plurality of mobile platforms comprises:
transmitting, based at least in part on utilization of the shared resource pool and before the time, the first content from a terrestrial server of the communication network to the at least the subset of the plurality of mobile platforms via the respective communication links; and
storing the first content in respective non-volatile memory devices of the respective servers

5. The method of claim 3, wherein distributing the first content to the at least the subset of the plurality of mobile platforms comprises:
transmitting, based at least in part on utilization of the shared resource pool and after the time, the first content from a terrestrial server of the communication network to the at least the subset of the plurality of mobile platforms; and
storing the first content in respective non-volatile memory devices of the respective servers.

6. The method of claim 5, wherein distributing the first content to the at least the subset of the plurality of mobile platforms comprises:
determining that a beam associated with a mobile platform of the at least the subset of the plurality of mobile platforms has resources that are in excess of resources used for traffic for a time period; and
transmitting at least a portion of the first content to the mobile platform via the beam using the resources during the time period.

7. The method of claim 6, wherein transmitting the first content to the mobile platform comprises:
transmitting, via the communication network, the at least the portion of the first content to two or more of the at least the subset of the plurality of mobile platforms via a set of multicast packets based at least in part on determining that the two or more of the at least the subset of the plurality of mobile platforms are within a same transmission beam.

8. The method of claim 6, further comprising:
determining that a second beam associated with the mobile platform has resources that are in excess of resources used for traffic for a second time period; and
transmitting at least a second portion of the first content to the mobile platform via the second beam during the second time period.

9. The method of claim claim 1, further comprising:
assigning a first priority for utilization of the shared resource pool to the first content and a second priority for utilization of the shared resource pool to second content for distribution to the at least the subset of the plurality of mobile platforms, the first priority higher than the second priority, based at least in part on a first time associated with the first content being available being before a second time associated with the second content being available.

10. The method of claim 9, further comprising:
receiving, after a second time associated with second content being available on the at least the subset of the plurality of mobile platforms, an access request for the second content from a device within a mobile platform of the at least the subset of the plurality of mobile platforms; and
determining whether the second content is stored on the respective server of the mobile platform based at least in part on the access request.

11. The method of claim 10, further comprising:
providing, based at least in part on determining that at least a portion of the second content is stored in the respective server, the at least the portion of the second content to the device.

12. The method of claim 10, further comprising:
allocating, based at least in part on determining that at least a portion of the second content is not stored in the respective server, a set of resources of the shared resource pool for streaming the at least the portion of the second content; and
streaming, based at least in part on allocating the set of resources, the at least the portion of the second content to the device.

13. The method of claim 12, further comprising:
storing the at least the portion of the second content on the respective server of the mobile platform based at least in part on streaming the at least the portion of the second content.

14. The method of claim 10, further comprising:
determining that a first portion of the second content is stored on the respective server of the mobile platform and a second portion of the second content is not stored on the respective server of the mobile platform;
providing the first portion of the second content to the device; and
transmitting, via the communication network, the second portion of the second content to the respective server of the mobile platform, wherein transmitting the second portion of the second content overlaps at least partially in time with providing the first portion of the second content.

15-28. (canceled)

29. An apparatus, comprising: a controller coupled with a memory device, wherein the controller is configured to cause the apparatus to:
provide an interface that enables distribution of content to respective servers on a plurality of mobile platforms, the content comprising entertainment content or information content to provide to devices within the plurality of mobile platforms, wherein the respective servers are coupled with a communication network via respective communication links established with the plurality of mobile platforms, wherein the respective communication links use a shared resource pool;
receive, via the interface a distribution request message for first content for distribution to at least a subset of the plurality of mobile platforms, the distribution request message comprising a plurality of distribution parameters, the plurality of distribution parameters comprising an indication of the at least the subset of the plurality of mobile platforms, a time at which the first content is scheduled to be available on the at least the subset of the plurality of mobile platforms, or both, wherein the at least the subset comprises two or more mobile platforms of the plurality of mobile platforms; and
distribute the first content to the at least the subset of the plurality of mobile platforms, wherein the distributing comprises determining resources of the respective communication links for distribution of the first content based at least in part on the plurality of distribution parameters and utilization of the shared resource pool.

30. The apparatus of claim 29, wherein the plurality of distribution parameters comprises the indication of the at least the subset of the plurality of mobile platforms.

31. The apparatus of claim 29, wherein the plurality of distribution parameters comprises the time at which the first content is scheduled to be available on the at least the subset of the plurality of mobile platforms.

32. The apparatus of claim 31, wherein distributing the first content to the at least the subset of the plurality of mobile platforms is configured to cause the apparatus to:
transmit, based at least in part on utilization of the shared resource pool and before the time, the first content from a terrestrial server of the communication network to the at least the subset of the plurality of mobile platforms via the respective communication links; and
store the first content in respective non-volatile memory devices of the respective servers.

33. The apparatus of claim 31, wherein distributing the first content to the at least the subset of the plurality of mobile platforms is configured to cause the apparatus to:
transmit, based at least in part on utilization of the shared resource pool and after the time, the first content from a terrestrial server of the communication network to the at least the subset of the plurality of mobile platforms; and
store the first content in respective non-volatile memory devices of the respective servers.

34. The apparatus of claim 29, wherein distributing the first content to the at least the subset of the plurality of mobile platforms is configured to cause the apparatus to:
determine that a beam associated with a mobile platform of the at least the subset of the plurality of mobile platforms has resources that are in excess of resources used for traffic for a time period; and
transmit at least a portion of the first content to the mobile platform via the beam using the resources during the time period.

35. The apparatus of claim 34, wherein transmitting the first content to the mobile platform is configured to cause the apparatus to:
transmit, via the communication network, the at least the portion of the first content to two or more of the at least the subset of the plurality of mobile platforms via a set of multicast packets based at least in part on determining that the two or more of the at least the subset of the plurality of mobile platforms are within a same transmission beam.

36. The apparatus of claim 34, wherein the controller is further configured to cause the apparatus to:
determine that a second beam associated with the mobile platform has resources that are in excess of resources used for traffic for a second time period; and
transmit at least a second portion of the first content to the mobile platform via the second beam during the second time period.

37. The apparatus of claim 29, wherein the controller is further configured to cause the apparatus to:
assign a first priority for utilization of the shared resource pool to the first content and a second priority for utilization of the shared resource pool to second content for distribution to the at least the subset of the plurality of mobile platforms, the first priority higher than the second priority, based at least in part on a first time associated with the first content being available being before a second time associated with the second content being available.

38. The apparatus of claim 29, wherein the controller is further configured to cause the apparatus to:
receive, after a second time associated with second content being available on the at least the subset of the plurality of mobile platforms, an access request for the second content from a device within a mobile platform of the at least the subset of the plurality of mobile platforms; and
determine whether the second content is stored on the respective server of the mobile platform based at least in part on the access request.

39. The apparatus of claim 38, wherein the controller is further configured to cause the apparatus to:
provide, based at least in part on determining that at least a portion of the second content is stored in the respective server, the at least the portion of the second content to the device.

40. The apparatus of claim 38, wherein the controller is further configured to cause the apparatus to:
allocate, based at least in part on determining that at least a portion of the second content is not stored in the respective server, a set of resources of the shared resource pool for streaming the at least the portion of the second content; and
streaming, based at least in part on allocating the set of resources, the at least the portion of the second content to the device.

41. The apparatus of claim 40, wherein the controller is further configured to cause the apparatus to:
store the at least the portion of the second content on the respective server of the mobile platform based at least in part on streaming the at least the portion of the second content.

42. The apparatus of claim 38, wherein the controller is further configured to cause the apparatus to:
determine, that a first portion of the second content is stored on the respective server of the mobile platform and a second portion of the second content is not stored on the respective server of the mobile platform;
provide the first portion of the second content to the device; and
transmit, via the communication network, the second portion of the second content to the respective server of the mobile platform, wherein transmitting the second portion of the second content overlaps at least partially in time with providing the first portion of the second content.
